(19) United States
(12) Patent Application Publication
(10) Pub. No.: US 2026/0153380 A1
(43) Pub. Date: Jun. 4, 2026

(54) WINDOW CAVITY WAFERS

(71) Applicant: MATERION CORPORATION, Mayfield Heights, OH (US)

(72) Inventors: Reto KELLER, Wetzikon ZH (CH); Richard KOBA, Saugas, MA (US)

(73) Assignee: MATERION CORPORATION, Mayfield Heights, OH (US)

(21) Appl. No.: 18/698,645

(22) PCT Filed: Oct. 4, 2022
(86) PCT No.: PCT/US2022/045669

§ 371 Date: Apr. 4, 2024

(51) Int. Cl. G01J 5/04; G01J 5/02; G01J 5/0802

(52) U.S. Cl. CPC G01J 5/045; G01J 5/0235; G01J 5/024; G01J 5/0802

(57) ABSTRACT

Techniques and/or systems are disclosed herein for forming a window cavity wafer that includes fabricating a window wafer by: providing a window wafer substrate having two faces; etching fiducials onto one or more faces of the window wafer substrate; and applying one or more optical coatings to on one or more faces of the window wafer substrate. Next, fabricating a spacer wafer separate from the window wafer by: providing a spacer wafer substrate having two faces; and forming an array of through-holes in the spacer wafer substrate. Then, bonding the spacer wafer to the window wafer to form the window cavity wafer; and forming discrete metal frames on a face of the window cavity wafer.

### RELATED APPLICATION DATA

This international application claims the benefit of U.S. Provisional Application No. 63/252,327, filed Oct. 5, 2021, which is incorporated by reference herein in its entirety.

### BACKGROUND

Current window cavity wafers (WCW) are formed from two wafers, such as silicon. One wafer is referred to as the spacer wafer and the other wafer is referred to as the window wafer. One or both wafers are oxidized, and then the two wafers are bonded together to form a void-free oxide bond. The bonded wafer is an example of the silicon-on-insulator (SOI) bonded wafer.

The preferred method to excavate cavities into the spacer wafer is deep reactive ion etching, or DRIE, also known as the Bosch Process. DRIE uses a special alternating plasma chemistry to etch Si with vertical sidewalls. Vertical sidewalls (anisotropic etching) are critical in order to minimize the waste of xy area between cavities. The width of the web between cavities must be maximized, and this is achieved by DRIE of the cavities with vertical sidewalls. The DRIE plasma chemistry is designed to cease etching when the cavity depth reaches the buried oxide layer, which serves as the etch stop. Therefore, DRIE is used to etch cavities that are 100-500 μm deep, as set by the thickness of the spacer wafer.

The top flat areas between cavities must be metallized in order to support the solder bonding of the WCW to the microbolometer/readout integrated circuit (ROIC) wafer. The metallization is done in the form of a rectangular frame that sits just outside the boundary of each cavity. The metal can either be one component of a solder that is formed during wafer bonding, the metal can be a solder itself, or the metal can be used for diffusion bonding to the matching metal frame on the ROIC wafer.

The sum of these numerous operations totals a significant cost for the WCW wafer, typically at least $1400.00 per 200 mm WCW wafer. This is the cost of the input WCW that then must be pattern coated with antireflective and blocker (long-pass) coatings, followed by pattern coating with getter thin film in the cavity. The non-planar nature of the cavity face of the WCW makes it challenging to pattern deposit the AR and blocker coatings and the getter coatings, since the cavities make it more difficult to deposit, pattern, and liftoff photoresist. The difficulty in processing cavity surfaces helps contribute to a higher level of defects in and on the AR and blocker coatings. Defects in the AR and blocker coatings are highly undesirable. Due to the high cost of the WCW input wafer, scrapping a WCW wafer due to defects in the AR and blocker coatings is very costly.

### SUMMARY

Provided herein is a window cavity wafer that comprises a window wafer including a window wafer substrate and one or more optical coatings disposed on one or more faces of the window wafer substrate. The window cavity wafer also comprises a spacer wafer including a spacer wafer substrate. The spacer wafer is wafer bonded to the window wafer to form the window cavity wafer. The window cavity wafer includes metal frames.

Provided herein is a method for forming a window cavity wafer that comprises fabricating a window wafer by: providing a window wafer substrate having two faces: etching alignment features on one or more faces of the window wafer substrate; and applying one or more optical coatings to on one or more faces of the window wafer substrate. The method further comprises fabricating a spacer wafer separate from the window wafer by: providing a spacer wafer substrate having two faces; and forming an array of through-holes in the spacer wafer substrate. The method also comprises bonding the spacer wafer to the window wafer to form the window cavity wafer; and forming discrete metal frames on a face of the window cavity wafer.

Also provided herein is a method for forming a window cavity wafer that comprises fabricating a window wafer by: providing a window wafer substrate having two faces: etching one or more faces of the window wafer substrate; and applying one or more optical coatings to on one or more faces of the window wafer substrate. The method further comprises fabricating a spacer wafer separate from the window wafer by: providing a spacer wafer substrate having two faces; and forming cavities on the faces of the spacer wafer substrate. The method also comprises bonding the spacer wafer to the window wafer to form the window cavity wafer; and forming discrete metal frames on a face of the window cavity wafer.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a cross-sectional view of an example embodiment of a window cavity wafer in accordance with this disclosure.

FIG. 2 is a cross-sectional view of an example embodiment of a window wafer that comprises part of the window cavity wafer of FIG. 1.

FIGS. 3A through 3C each diagrammatically show a cross-sectional view of a spacer wafer that can comprise part of the window cavity wafer of FIG. 1.

FIG. 4 is a perspective view illustrating an example of wafer bonding between a window wafer and a spacer wafer to form a window cavity wafer in accordance with this disclosure.

FIG. 5 is a process flow diagram illustrating an example implementation of a wafer level processing (WLP) method for producing a window cavity wafer in accordance with this disclosure.

FIGS. 6A and 6B are flow diagrams illustrating example implementations of a method for fabricating a window wafer in accordance with this disclosure.

FIGS. 7A through 7E are flow diagrams illustrating example implementations of a method for fabricating a spacer wafer in accordance with this disclosure.

FIG. 8 is a flow diagram illustrating an example implementation of a method for forming a window cavity wafer as shown in FIG. 1 by combining a window wafer and a spacer wafer each respectively fabricated according to the methods of FIGS. 6A through 6B and FIGS. 7A through 7E of this disclosure.

FIGS. 9A through 9C are cross-sectional views showing steps for forming a window cavity wafer by combining a window wafer and a spacer wafer each respectively fabricated separately in accordance with this disclosure.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the terms “comprise(s),” “include(s),” “having.” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

This disclosure provides for anti-reflective (AR) and/or long-pass blocker coatings to be pattern deposited on a window wafer having two planar faces as a first step. As an example, the window wafer can comprise a double-side polished planar Si wafer with a front side and a backside. Cavities can be formed as a subsequent step by wafer bonding a perforated spacer wafer having a thickness that is approximately the depth of the cavity. This disclosure is also applicable/compatible with a wide a variety of alternative window wafers (e.g., Si, Ge, glass, sapphire) and matching perforated spacer wafers (e.g., Si, glass, sapphire, ceramic, metal alloy) since the wafer bonding materials and methods can be tailored to the materials used for the window and spacer.

The fabrication method disclosed herein comprises a novel sequence of operations that result in a window cavity wafer. Conventionally, fabrication of a window cavity wafer includes processing a silicon on insulator (SOI) bonded wafer in the following sequence: metallization of frames in a grid pattern, followed by patterned deep reactive ion etching (DRIE) to create cavities in the wafer, followed by patterned deposition of AR/blocker coatings and patterned deposition of getter thin film. In the present disclosure, the fabrication of the patterned AR/blocker coatings on the window wafer occurs first, which is then followed by bonding of a metallized, perforated spacer wafer to create an array of cavities. Getter deposition is performed on the window cavity wafer as a final step. As will be appreciated, this technique provides a higher yield at a lower cost than traditional techniques.

This disclosure provides numerous technical benefits such as, but not limited to the following: cost reduction and yield improvement: greater range of cavity depth: no incompatibility with lithography chemicals; and wider range of window and spacer material combinations.

### Device/Apparatus

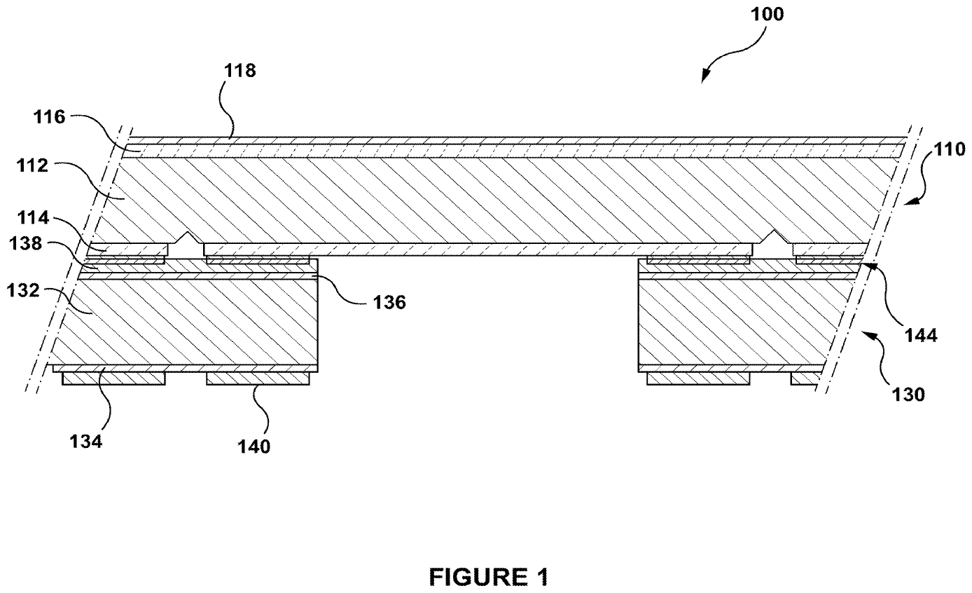

With reference to FIG. 1, an example embodiment of a window cavity wafer (WCW) 100 is shown. The window cavity wafer 100 can include a window wafer 110 and a spacer wafer 130 that are each individually fabricated and processed. At a later stage, the window wafer 110 and the spacer wafer 130 are bonded together, as generally represented by the bonding line 144, thereby producing the window cavity wafer 100.

Referring now to FIGS. 1-4, the window wafer 110 can include a window wafer substrate 112 and one or more optical coatings 114 and 116 disposed on the window wafer substrate 112. The window wafer substrate 112 can be two-sided (i.e., have a front side and a backside) and has two generally planar faces. In some embodiments, the window wafer substrate 112 can have a thickness between 300 μm and 1000 μm and may be substantially transparent to infrared light. By way of illustrative example, the window wafer substrate 112 can include silicon (Si), germanium (Ge), glass (e.g., borofloat glass), and sapphire. In some embodiments, the window wafer substrate 112 can include a double-sided polished 200 mm (8-in diameter) Si wafer having a thickness between 300 μm and 1000 μm such as, for example, about 400 μm. In other embodiments, the window wafer substrate 112 can include a double-sided polished 200 mm wafer composed of Borofloat 33 glass (e.g., borosilicate glass or equivalent) having a thickness between 300 μm and 1000 μm.

One or more optical coatings 114 and 116 can be disposed on the window wafer substrate 112. The optical coating 114 is disposed over the front face (i.e., front side) of the window wafer substrate 112 and optical coating 116 is disposed over the back face (i.e., or backside) of the window wafer substrate 112. By way of illustrative example, the optical coatings 114 and 116 can include an antireflective (AR) coating, an optical filter coating, or a blocker coating. Optionally, a diamond-like carbon (DLC) coating 118 can be disposed over the optical coating 116 on the backside of the window wafer substrate 112.

In some embodiments, the window wafer substrate 112 is made of Si and includes an optical coating 116 formed on its backside comprising a long-pass infrared (LWIR) optical coating and an optical coating 114 formed on its front side comprising a LWIR AR coating. In some embodiments, the window wafer 110 optionally can include a diamond-like carbon (DLC) coating 118 that is disposed over the optical coating 116, such as an AR coating, to protect the optical coating 116 from scratching during subsequent wafer bonding processes. In other embodiments, each of the optical coatings 114 and 116 on the respective front side and backside of the Si window wafer substrate 112 include an AR coating in the long-pass infrared (e.g., LWIR AR coating) and a blocker coating. In still other embodiments, the window wafer substrate 112 is made of Borofloat 33 glass and includes an optical coating 116 formed on its backside (e.g., a visible, near-infrared (NIR) or short-wave infrared (SWIR) AR coating or filter) and optical coating 114 formed on its front side (e.g. a visible, NIR or SWIR AR coating).

The spacer wafer 130 can include a spacer wafer substrate 132 and one or more metal layers 134 and 136, for example seed layers (or stacks) or electroplated layers, disposed on the spacer wafer substrate 132. In some embodiments, a glass layer 142 can be disposed on the spacer wafer substrate 132. The spacer wafer 130 can be a perforated spacer wafer.

The spacer wafer substrate 132 can be two-sided (i.e., has a front side and a backside) and has two faces. In some embodiments, the spacer wafer substrate 132 can have a thickness between 100 μm and 700 μm and, in particular embodiments, can have a thickness between 100 μm and 500 μm. By way of illustrative example, the spacer wafer substrate 132 may include glass, sapphire, ceramic, or metal alloy. In some embodiments, the spacer wafer substrate 132 can include a double-sided polished 200 mm (8-in diameter) Si wafer having a thickness between 100 μm and 700 μm. In some embodiments, the Si wafer may have a thickness between 100 μm and 500 μm such as, for example, about 200 μm. In other embodiments, the spacer wafer substrate 132 can include a double-sided polished 200 mm borosilicate glass wafer or an Invar perforated wafer.

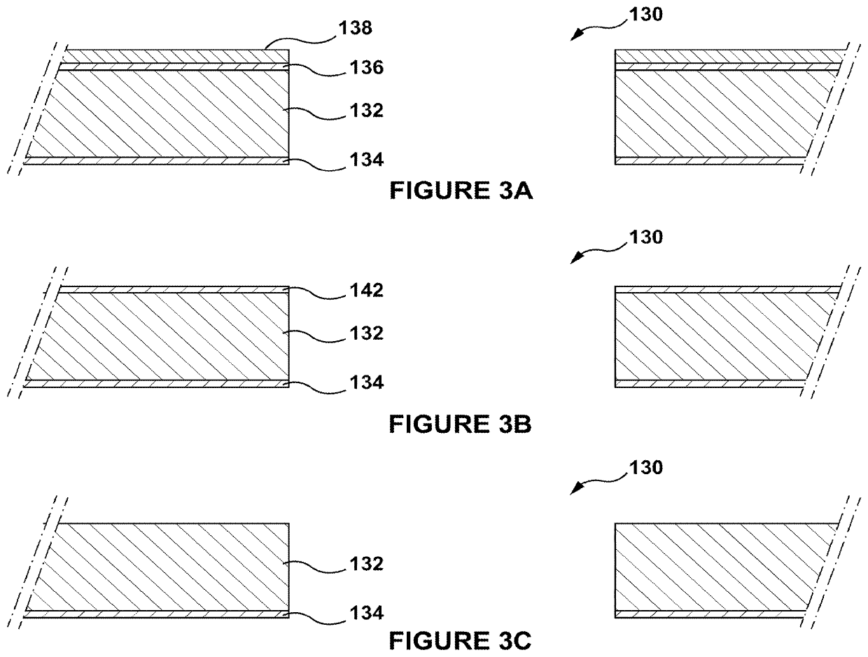

One or more metal layers 134 and 136 can be disposed on the spacer wafer substrate 132. In some embodiments, the metal layers 134, 136 can include a seed layer stack (e.g., 136 in FIG. 3A) disposed on the backside of the spacer wafer substrate 132 and/or a seed layer stack (e.g., 134 in FIGS. 3A-3C) disposed on the front side of the spacer wafer substrate 132. By way of illustrative example, the standard seed layer stack can include Cr+Ni+Au or Ti+Pt+Au. In some embodiments, the top layer of sputtered gold (Au) in the seed layer stack can have a thickness of 100 nm to 300 nm in order to minimize cost. In other embodiments, the metal layers 134, 136 can include electroplated layers of Ni disposed on the spacer wafer substrate 132 (e.g., Invar wafer). In those embodiments, the plated Ni layers can have a thickness between 1-2 μm.

In some embodiments, the spacer wafer 130 can further include a metal plating layer 138 disposed over the seed layer stack (e.g., 136 in FIGS. 1 and 3A) on the backside of the spacer wafer substrate 132. The backside of the spacer wafer substrate 132 can be electroplated with gold to a thickness of 1-4 μm to form the plating layer 138. In other embodiments, the spacer wafer 130 can further include a metal plating layer 138 (e.g., gold) having a thickness between 1-10 microns disposed over the plated Ni metal layer 136 on the backside of the spacer wafer substrate 132.

In some embodiments, the spacer wafer 130 can further include a metal plating layer 140 disposed over the seed layer stack (e.g., 134 in FIG. 1) on the front side of the spacer wafer substrate 132. The front side of the spacer wafer substrate 132 can be electroplated with gold to a thickness of 1-4 μm to form the plating layer 140. In other embodiments, the spacer wafer 130 can further include a metal plating layer 140 (e.g., gold) having a thickness between 1-10 microns disposed over the plated Ni metal layer 134 on the backside of the spacer wafer substrate 132.

In some embodiments, a glass layer 142 can be disposed on the spacer wafer substrate 132, as shown in FIG. 3B. In these embodiments, a glass layer 142, such as borosilicate glass (e.g., similar to Corning 7740), can be disposed on a spacer wafer substrate 132 (e.g., Si wafer). The glass layer 142 can have a thickness between 3 μm to 10 μm.

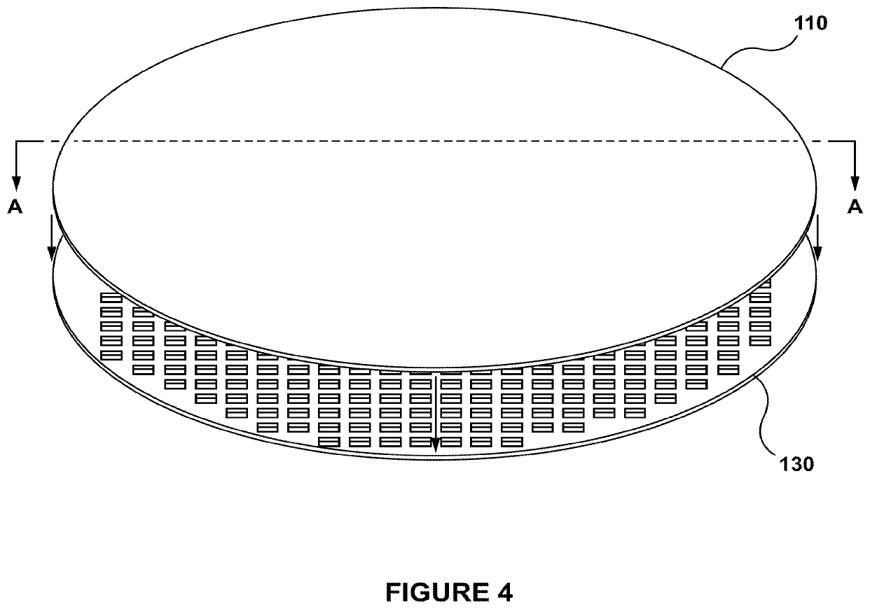

Referring now to FIG. 4, there is an example of wafer bonding between a window wafer 110 and a spacer wafer 130. The spacer wafer 130 is perforated. An array of cavities can be established by wafer bonding the window wafer 110 to the perforated spacer wafer 130 that has a thickness that is approximately the depth of the cavity. Various types of wafer bonding can be implemented in accordance with this disclosure including, but not limited to, one or more of anodic bonding, solder bonding (e.g., eutectic bonding), and laser bonding.

Under conventional techniques, cavities are excavated by DRIE. As a result, the cost and difficulty of creating an acceptable cavity increases as cavity depth increases. When excavating using DRIE, it is important that the sidewalls of the cavity be nearly vertical in order to minimize consumption of lateral (xy) real estate.

This disclosure recognizes the advantages to increasing the depth of the cavity, such as reducing the sensitivity of the microbolometer array to defects in the AR coatings on the window wafer which manifest as “crop circle” defects in the image. In this disclosure, the depth of the cavity is controlled by the thickness of the perforated spacer wafer 130, which can range from 100 μm to 700 μm with minor differences in cost based on thickness. In some embodiments, the thickness of the perforated spacer wafer 130 may be between 100 μm and 500 μm. For spacer wafers 130 that are made of materials such as glass, Si and metal, cost can be minimized by creating through-holes with wet chemicals, or by laser machining or ultrasonic machining or by sand blasting. Standard wafer bonders can align two 200 mm wafers to an accuracy of #1 μm at elevated temperature prior to solder bonding or anodic bonding. Therefore, this disclosure beneficially provides for greater range of cavity depth than conventional techniques and related structures.

### METHOD

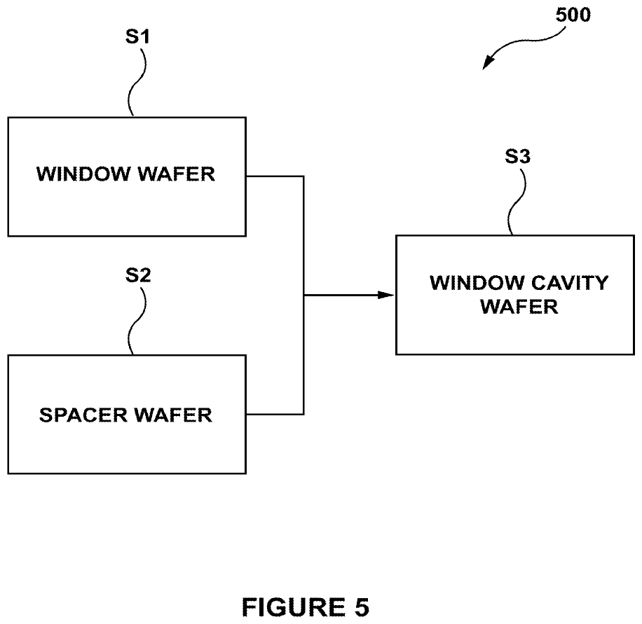

Following is a description of an example implementation of a method 500 (FIG. 5) by which the example window cavity wafer 100 of FIG. 1, as well as other window cavity wafers, may be manufactured reliably and efficiently in volume quantities using wafer level packaging (WLP) techniques disclosed herein. As illustrated in the top level overview of the method in FIG. 5, in one implementation, the example method 500 may begin at stage or step 1 (S1) with the fabrication of a “window wafer” (e.g., 110 in FIG. 1) and at S2 with fabrication of a “spacer wafer” (e.g., 130 in FIG. 1) as described in more detail below: The method then proceeds at S3 with the WLP processes that combine the two wafers (e.g., window wafer 110 and spacer wafer 130 in FIG. 1) into an assembly and process the assembly (e.g., through bonding of the wafers) that results in the “window cavity wafer” (e.g., 100 in FIG. 1).

The method provided herein advantageously provides for window cavity wafers that can be made from a wider range of window wafer and spacer wafer material combinations. Because the window wafer and spacer wafer are fabricated separately before being joined together by wafer bonding at a later stage, a wider range of window wafer and spacer wafer material combinations are available. Thus, the method disclosed herein provides an advantage over conventional techniques that require single-sided anisotropic etching of cavities into a bonded wafer, thereby limiting the window wafer to Si or glass.

For example, in one non-limiting example, this disclosure provides for a Si window wafer to be bonded to a perforated spacer wafer of Si, glass, or metal for wafer level packaging of near-infrared (NIR), middle-wave infrared (MWIR), and long-wave infrared (LWIR) detectors and focal plane arrays. In another non-limiting example, this disclosure provides for a silicate glass window wafer to be bonded to a perforated spacer wafer of Si, glass, or metal for wafer level packaging of UV, visible, and NIR detectors and focal plane arrays. In another non-limiting example, this disclosure provides for a sapphire window wafer to be bonded to a perforated spacer wafer of glass, ceramic, or metal for wafer level packaging of UV, visible. NIR, and short wavelength infrared (SWIR) detectors and focal plane arrays. In another non-limiting example, this disclosure provides for a germanium (Ge) window wafer to be bonded to a perforated spacer wafer of glass, ceramic, or metal for wafer level packaging of NIR, SWIR, MWIR, and LWIR detectors and focal plane arrays. In yet another non-limiting example, this disclosure provides for a chalcogenide glass window wafer to be bonded to a perforated spacer wafer of glass, ceramic, or metal for wafer level packaging of NIR, MWIR, and LWIR detectors and focal plane arrays.

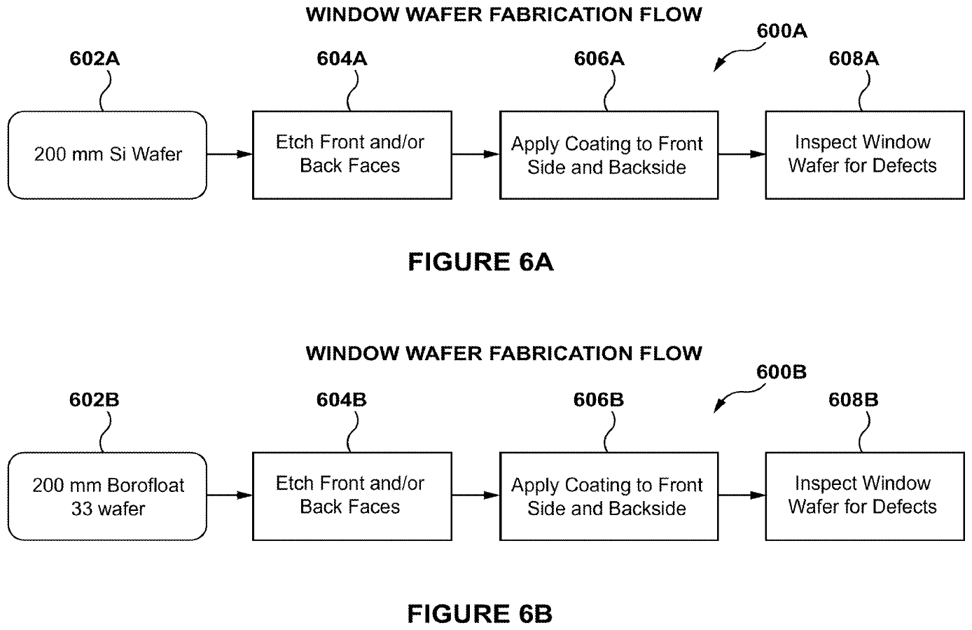

As illustrated in detail in FIGS. 6 through 8, the example WLP method 500 includes two methods, viz., a “window wafer” fabrication method 600A and 600B and a “spacer wafer” fabrication method 700A-700E, the products of which are combined into yet a third “window cavity wafer assembly and bonding” method 800. The various stages set forth in FIGS. 6 through 8 are described in detail as follows for one or more embodiments.

In one non-limiting example implementation, FIGS. 6A, 7A, and 8 collectively provide a flow diagram illustrating a Si window wafer and a Si spacer wafer that are each fabricated separately and then bonded together at a later stage through solder bonding (e.g., a eutectic bond) to form a window cavity wafer. In another non-limiting example implementation, FIGS. 6A, 7B, and 8 collectively provide a flow diagram illustrating a Si window wafer and a Si spacer wafer that are each fabricated separately and then bonded together at a later stage through anodic bonding to form a window cavity wafer. In yet another non-limiting example implementation, FIGS. 6A, 7C, and 8 collectively provide a flow diagram illustrating a Si window wafer and a glass spacer wafer that are each fabricated separately and then bonded together at a later stage through anodic bonding to form a window cavity wafer. In another non-limiting example implementation, FIGS. 6A, 7D, and 8 collectively provide a flow diagram illustrating a Si window wafer and an Invar 36 spacer wafer that are fabricated separately and then bonded together at a later stage through solder bonding (e.g., eutectic bond) or alternatively through diffusion bonding, to form a window cavity wafer. In still another non-limiting example implementation, FIGS. 6B, 7E, and 8 collectively provide a flow diagram illustrating a Borofloat 33 glass window wafer and a Si spacer wafer that are each fabricated separately and then bonded together at a later stage through anodic bonding to form a window cavity wafer. In yet another non-limiting example implementation, FIGS. 6A, 7E, and 8 collectively provide a flow diagram illustrating a Si window wafer and a Si spacer wafer that are each fabricated separately and then bonded together at a later stage through laser bonding to form a window cavity wafer. FIGS. 6A, 7C, and 8 collectively provide a flow diagram illustrating a Si window wafer and a glass spacer wafer that are each fabricated separately and then bonded together at a later stage through laser bonding to form a window cavity wafer. In still another non-limiting example implementation, FIGS. 6B, 7E, and 8 collectively provide a flow diagram illustrating a Borofloat 33 glass window wafer and a Si spacer wafer that are each fabricated separately and then bonded together at a later stage through laser bonding to form a window cavity wafer. In yet another non-limiting example implementation, FIGS. 6B, 7C, and 8 collectively provide a flow diagram illustrating a Borofloat 33 glass window wafer and a glass spacer wafer that are each fabricated separately and then bonded together at a later stage through laser bonding to form a window cavity wafer.

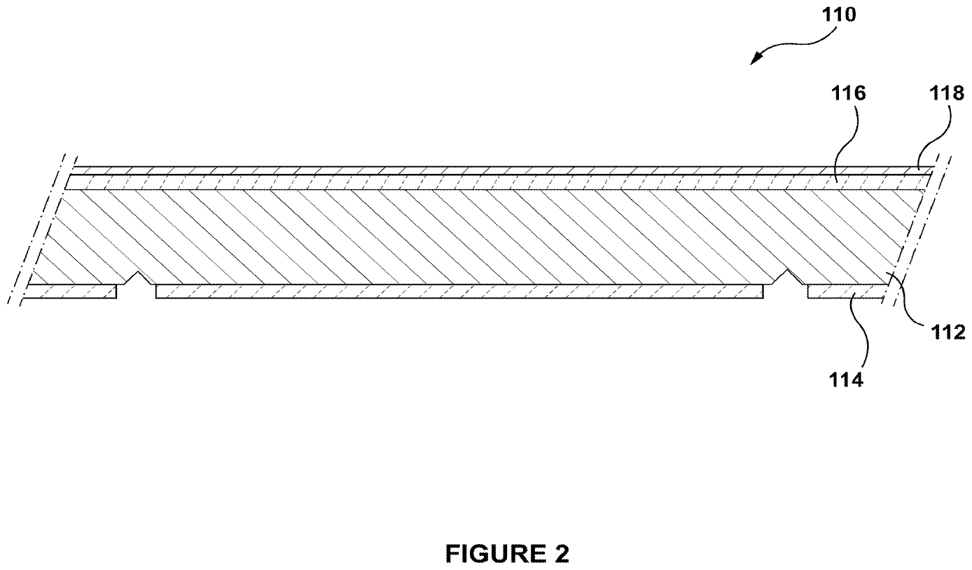

Referring now to FIGS. 6A and 6B, there are flow diagrams illustrating example implementations of a method 600A and 600B for fabricating a window wafer (e.g., 110 of FIG. 2).

Referring first to FIG. 6A, at 602A a two-sided (i.e., a front side and a backside) window wafer substrate (e.g., 112 in FIG. 2) having two planar faces is provided. In this implementation, the window wafer substrate (e.g., 112 in FIG. 2) comprises a double-sided polished 200 mm Si wafer having a thickness between 300 μm and 1000 μm. In other implementations, the window wafer substrate (e.g., 112 in FIG. 2) may comprise Ge, glass, or sapphire. At 604A, the Si wafer can be etched with shallow (<5 μm deep) fiducial (alignment) marks and saw streets by wet etching or dry etching on one or both of the faces (i.e., the front side and backsides) of the Si wafer. The etched features can be defined by using lithography.

At 606A, one or more coatings (e.g., 114 and 116 in FIG. 2), for example AR coatings and blocker coatings, can be applied to the front side and backside of the Si wafer. In some implementations, the backside of the Si wafer can be blanket coated with a long-pass LWIR optical coating, while the front side of the Si wafer can be coated with a LWIR AR coating in a 2-D array of rectangles (e.g., or other shape) defined by lift-off lithography. In these implementations, an optional diamond-like carbon (DLC) coating (e.g., 118 in FIG. 2) can be deposited over the LWIR coating on the backside of the Si wafer.

In other implementations, both the front side and backside faces of the Si wafer are coated with an AR coating in the LWIR and a blocker coating with a cut-on between 7 and 8 microns of wavelength. In those implementations, the backside of the window wafer substrate is blanket coated with these AR and blocker coatings, while the front side of the window wafer substrate includes these coatings in a 2-D array of rectangles (e.g., or other shape) defined by lift-off lithography. In those implementations, an optional diamond-like carbon (DLC) coating (e.g., 118 in FIG. 2) can be deposited over the blanket LWIR AR coating on the backside of the Si wafer to protect the coating from scratching during subsequent two wafer bonding processes.

At 608A, the fabricated Si window wafer (e.g., 110 in FIG. 2) can be inspected for defects. For example, after the lift-off process, the front face of the window wafer (e.g., 110 in FIG. 2) can be inspected to make sure all the bare Si streets between the AR coating rectangles are clean and free of any coating or photoresist residue. In another example, the array of AR and blocker coatings on both sides of the window wafer can be inspected for defects such as scratches, digs, and/or particles. If the window wafer is found to have too high a density or number of defects in the optical coatings, the window wafer can be either discarded or stripped, re-polished and then reused. Thus, only if the quality and yield of the patterned AR, filter, and/or blocker coatings are sufficiently high will further unit operations be performed on this planar window wafer, namely, bonding to a perforated spacer wafer, which may be a metallized perforated spacer wafer.

Referring to FIG. 6B, at 602B a two-sided (i.e., a front side and a backside) window wafer substrate (e.g., 110 in FIG. 2) having two planar faces is provided. In this implementation, the window wafer substrate (e.g., 110 in FIG. 2) is a double-sided polished 200 mm wafer composed of Borofloat 33 glass (e.g., borosilicate float glass or equivalent) having a thickness between 300 μm and 1000 μm. At 604B, the Borofloat 33 glass wafer can be etched with shallow (<5 μm deep) fiducial marks and saw streets by wet etching or dry etching on one or both of the faces (i.e., the front side and backsides) of the Borofloat 33 glass wafer. In this implementation, the etched features can be defined by using lithography. In other implementations, the fiducial marks can be made by a laser.

At 606B, one or more coatings (e.g., 114 and 116 in FIG. 2), for example AR coatings and optical filter coatings, can be applied to the front side and backside of the Borofloat 33 glass wafer. In some implementations, the backside of the Borofloat 33 glass wafer can be blanket coated with a visible, near-infrared (NIR) or short-wave infrared (SWIR) AR coating or filter, while the front side of the Borofloat 33 glass wafer can be coated with a visible, NIR or SWIR AR coating in a 2-D array of rectangles (e.g., or other shape) defined by lift-off lithography.

At 608B, the fabricated Borofloat 33 glass window wafer (e.g., 110 in FIG. 2) can be inspected for defects. For example, after the lift-off process, the front face of the Borofloat 33 glass window wafer (e.g., 110 in FIG. 2) can be inspected to make sure all the streets between the AR coating rectangles are clean and free of any coating or photoresist residue. In another example, the array of AR and filter coatings on both faces of the window wafer can be inspected for defects such as scratches, digs, and/or particles. If the window wafer is found to have too high a density or number of defects in the optical coatings, the window wafer can be either discarded or stripped, re-polished and then reused. Thus, only if the quality and yield of the patterned AR, filter, and/or blocker coatings are sufficiently high will further unit operations be performed on this planar window wafer, namely, bonding to a perforated spacer wafer, which may be a metallized perforated spacer wafer.

As disclosed herein, fabrication of the window wafer (e.g., 110 in FIG. 2) occurs prior to wafer bonding and metallization. Therefore, any lithography steps required for the deposition of the AR coatings and blocker coatings on the window wafer are completed prior to wafer bonding and metallization (if present). Advantageously, this disclosure experiences no incompatibility with lithography chemicals because the lithography chemicals are used prior to wafer bonding and metallization. Thus, the metallization is not exposed to the lithography chemicals and does not experience any resulting corrosion from the lithography chemicals.

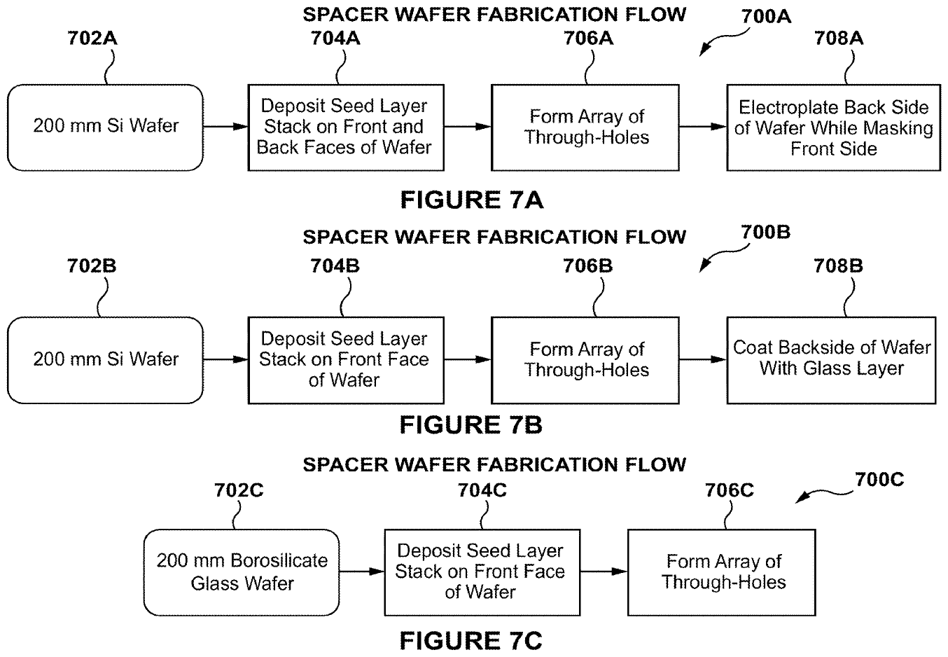

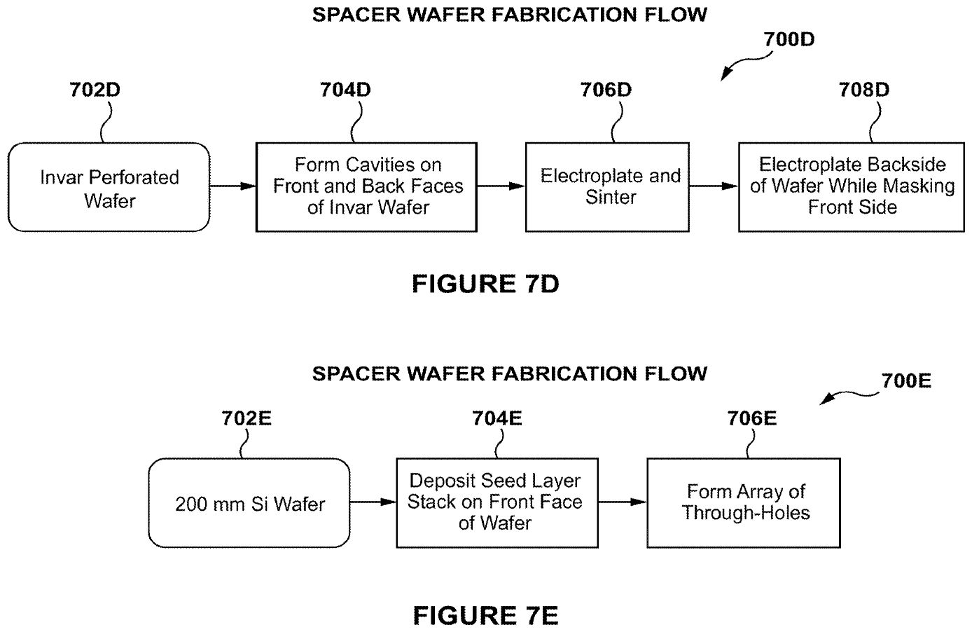

Referring now to FIGS. 7A through 7E, there are flow diagrams illustrating example implementations of a method 700A, 700B, 700C, 700D, and 700E for fabricating a spacer wafer (e.g., 130 in FIGS. 3A and 3B).

Referring to FIG. 7A, at 702A a two-sided (i.e., a front side and a backside) spacer wafer substrate (e.g., 132 in FIG. 3A) having two faces is provided. In this implementation, the spacer wafer substrate (e.g., 132 in FIG. 3A) is a double-sided polished 200 mm Si wafer having a thickness between 100 μm and 700 μm, for example, between 100 μm and 500 μm. In other implementations, the spacer wafer substrate (e.g., 132 in FIG. 3A) may include glass, sapphire, ceramic, or metal alloy. At 704A, a standard seed layer stack (e.g., 134 and 136 in FIG. 3A) is blanket sputter deposited on both faces (e.g., front face and back face) of the Si wafer. The standard seed layer stack can comprise Cr+Ni+Au or Ti+Pt+Au. In some implementations, the top layer of sputtered gold (Au) can have a thickness of 100 nm to 300 nm in order to minimize cost.

At 706A, an array of through-holes is formed in the Si spacer wafer according to the desired array. In some implementations, an array of rectangular through-holes is formed in the Si spacer wafer, but other shapes are envisioned by this disclosure. The method of forming the through-holes is not impeded by the metallization on both faces of the spacer wafer substrate and can include wet etching, laser, waterjet, or ultrasonic machining. At 708A, the backside of the spacer wafer is electroplated with gold to a thickness of 1 μm-4 μm to form a plating layer (e.g., 138 in FIG. 3A) while the opposing, front side is masked during electroplating.

Referring to FIG. 7B, at 702B a two-sided (i.e., a front side and a backside) spacer wafer substrate (e.g., 132 in FIG. 3B) having two faces is provided. In this implementation, the spacer wafer substrate (e.g., 132 in FIG. 3B) is a double-sided polished 200 mm Si wafer having a thickness between 100 μm and 700 μm, for example between 100 μm and 500 μm. In other implementations, the spacer wafer substrate (e.g., 132 in FIG. 3B) may include glass, sapphire, ceramic, or metal alloy. At 704B, a standard seed layer stack (e.g., 134 in FIG. 3B) is blanket metallized (e.g., sputter deposited) on the front face of the Si wafer. The standard seed layer stack can include Cr+Ni+Au or Ti+Pt+Au. In some implementations, the top layer of sputtered gold (Au) can have a thickness of 100 nm to 300 nm in order to minimize cost.

At 706B, an array of rectangular (e.g., or other shape) through-holes is formed in the Si spacer wafer in the desired array. The method of forming the through-holes is not impeded by the metallization on one face of the spacer wafer substrate and can include wet etching, laser, waterjet, or ultrasonic machining. At 708B, the backside of the spacer wafer is coated with a glass layer (e.g., 142 in FIG. 3B), such as borosilicate glass (e.g., similar to Corning 7740). In some non-limiting examples, the glass layer (e.g., 142 in FIG. 3B) can be deposited by evaporation, plasma assisted evaporation (plasma-enhanced chemical vapor deposition), or sputtering to a thickness between 3 μm to 10 μm. The borosilicate glass contains a sufficient concentration of alkaline ions (like Na+) to promote anodic bonding.

Referring to FIG. 7C, at 702C a two-sided (i.e., a front side and a backside) spacer wafer substrate (e.g., 132 in FIG. 3A) having two faces is provided. In this implementation, the spacer wafer substrate (e.g., 132 in FIG. 3A) is a double-sided polished 200 mm borosilicate glass wafer having a thickness between 100 μm and 700 μm, for example, between 100 μm and 500 μm. It is advantageous for the borosilicate glass to have the same coefficient of thermal expansion (CTE) as silicon, and a sufficient content of alkali ions to promote anodic bonding (e.g., Corning 7740) or BoroFloat 33) when anodic bonding is used to bond the spacer wafer to the window wafer. At 704C, a standard seed layer stack (e.g., 134 in FIG. 3A) is blanket sputter deposited on the front face of the borosilicate glass wafer. The standard seed layer stack can include Cr+Ni+Au or Ti+Pt+Au. In some implementations, the top layer of sputtered gold can have a thickness of 100 nm to 300 nm in order to minimize cost. It will be appreciated that the metallization step 704C may not be included (i.e., is optional) if laser bonding is used to bond the spacer wafer to the window wafer because direct laser bonding does not require metal or metal-seed layers for bonding.

At 706C, an array of rectangular (e.g., or other shapes) through-holes is formed in the glass spacer wafer in the desired array. The method of forming the through-holes is not impeded by the metallization on one face of the spacer wafer and can include wet etching, laser, waterjet, or ultrasonic machining.

Referring to FIG. 7D, at 702D a two-sided (i.e., a front side and a backside) spacer wafer substrate (e.g., 132 in FIG. 3A) having two faces is provided. In this implementation, the spacer wafer substrate (e.g., 132 in FIG. 3A) is an Invar perforated wafer having a thickness between 100 μm and 700 μm, for example, between 100 μm and 500 μm. It is advantageous for the desired Invar alloy and temper to have a coefficient of thermal expansion (CTE) as close as possible to the CTE of Si. At 704D, one or more cavities are formed in the Invar by wet photoetching from both faces on the Invar sheet in order to maintain the sidewalls of the cavity to be as vertical as possible.

At 706D, the Invar is electroplated with 1-2 microns of Ni to form metal plating layers on both faces on the Invar (e.g., 134 and 136 in FIG. 3A) and then sintered to remove plating salts. The Invar wafer is then masked on the front face so that the next electroplating step only occurs on the backside face. At 708D, the backside of the Invar is then electroplated with gold to a thickness of 1-10 microns to form a plating layer (e.g., 138 in FIG. 3A), while the opposing, front side is masked during electroplating.

Referring to FIG. 7E, at 702E a two-sided (i.e., a front side and a backside) spacer wafer substrate (e.g., 132 in FIG. 3A) having two faces is provided. In this implementation, the spacer wafer substrate (e.g., 132 in FIG. 3A) is a double-sided polished 200 mm Si wafer having a thickness between 100 μm and 700 μm, for example, between 100 μm and 500 μm. In other implementations, the spacer wafer substrate may include glass, sapphire, ceramic, or metal alloy. At 704E, a standard seed layer stack (e.g., 134 in FIG. 3A) is blanket metallized (e.g., sputter deposited) on the front face of the Si spacer wafer substrate. The standard seed layer stack can include Cr+Ni+Au or Ti+Pt+Au. In some implementations, the top layer of sputtered gold can have a thickness of 100 nm to 300 nm in order to minimize cost. It will be appreciated that the metallization step 704E may not be included (i.e., is optional) if laser bonding is used to bond the spacer wafer to the window wafer because direct laser bonding does not require metal or metal-seed layers for bonding.

At 706E, an array of rectangular (e.g., or other shape) through-holes is formed in the Si spacer wafer in the desired array. The method of forming the through-holes is not impeded by the metallization on one face of the Si spacer wafer and can include wet etching, laser, waterjet, or ultrasonic machining.

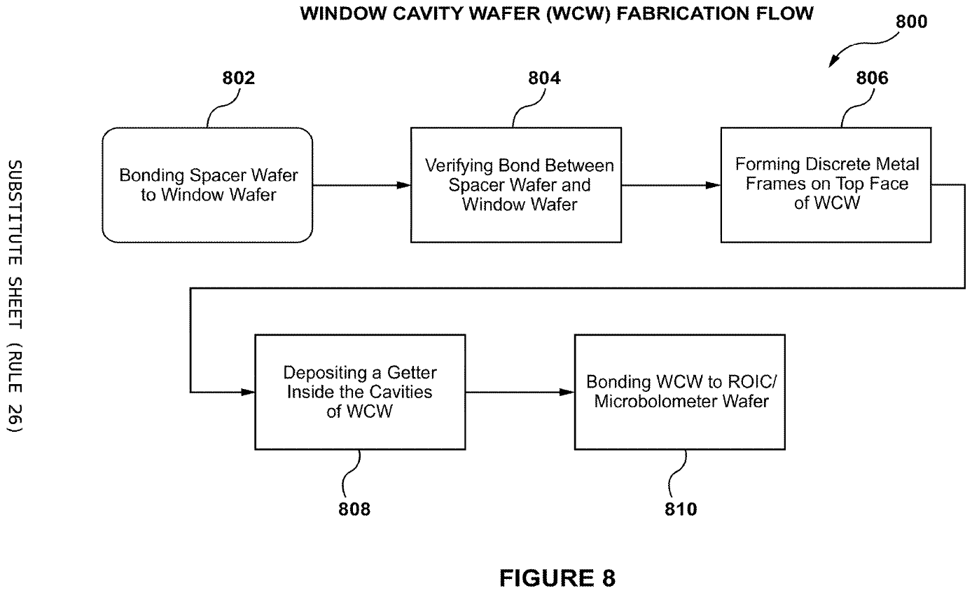

Referring now to FIG. 8, there is a flow diagram illustrating an example implementation of a method 800 for forming a window cavity wafer (e.g., 100 in FIG. 1) from the spacer wafers fabricated according to the method of FIGS. 7A through 7E, and the window wafers fabricated according to the method of FIGS. 6A and 6B. In particular, the “window cavity wafer” or WCW results from a spacer wafer hermetically bonded to a window wafer.

At 802, the spacer wafer (e.g., 130 in FIG. 1) is bonded to the window wafer (e.g., 110 in FIG. 1). In some implementations, the spacer wafer (fabricated by the method of FIG. 7A) and the window wafer (fabricated by the method of FIG. 6A) can be placed in a wafer bonder for vacuum bonding at 390-415° C. to form an Au/Si eutectic alloy between the backside of the spacer wafer and the front side of the window wafer. The Au/Si eutectic alloy binds the spacer wafer and window wafer together through Au/Si eutectic bonding. In other implementations, the spacer wafer (fabricated by the method of FIGS. 7B-7C) and the window wafer (fabricated by the method of FIG. 6A) can be placed in a wafer bonder for anodic bonding at 390-450° C. in vacuum in which the bonding occurs between Si and glass. In still other implementations, the Invar spacer wafer (fabricated by the method of FIG. 7D) and the window wafer (fabricated by the method of FIG. 6A) can be placed in a wafer bonder for bonding at 390-450° C. to form AuSi solder between the Invar and the window wafer. Alternatively, the matching streets on the window wafer can be coated with germanium (to form AuGe solder during bonding) or with electroplated gold (to form a gold-gold diffusion bond). In yet other implementations, the bare silicon face of the spacer wafer (fabricated by the method of FIG. 7E) and the patterned face of the glass window wafer (fabricated by the method of FIG. 6B) are pressed together, and then anodically bonded under vacuum at 350-400° C. In still other implementations, the Si spacer wafer (fabricated by the method of FIG. 7E) and the Si window wafer (fabricated by the method of FIG. 6A) are bonded together using direct laser bonding. It is conceivable that an infrared (IR) laser can be used to perform the laser bonding. In yet other implementations, the Si spacer wafer (fabricated by the method of FIG. 7E) and the glass window wafer (fabricated by the method of FIG. 6B) are bonded together using direct laser bonding. In still other implementations, the glass spacer wafer (fabricated by the method of FIG. 7C) and the Si window wafer (fabricated by the method of FIG. 6A) are bonded together using direct laser bonding. In yet other implementations, the glass spacer wafer (fabricated by the method of FIG. 7C) and the glass window wafer (fabricated by the method of FIG. 6B) are bonded together using direct laser bonding.

It will be appreciated that bonding a window wafer to a spacer wafer via laser bonding offers many advantages. First, the laser bonding can be performed at low temperature, such as at room temperature, which advantageously mitigates heat-related damage to any previously-formed optical coatings and other active layers. Thus, the window wafer and/or spacer wafer substrates can be coated before laser treatment. Laser bonding provides a minimal heat load because the heat-affected zone (i.e., the laser treatment zone) is very small—for example, only a few micrometers. Additionally, low heat allows for the use of less bulk/material and, thus, permits the use of thinner materials. Second, direct laser bonding provides for bonding between the spacer wafer and window wafer without requiring additive materials, such as adhesives, and without leaving a gap between the window wafer and the spacer wafer. It will be further appreciated that no adhesives means no outgassing and direct laser bonding does not require metal or metal-seed layers for bonding. It is conceivable that infrared (IR) lasers may be used as the laser source to bond a Si spacer wafer to a Si window wafer.

It can be difficult to anodically bond a glass wafer (e.g., perforated borosilicate glass wafer) that is thinner than 400 μm to a silicon wafer without excessive warpage of the glass and potentially fracture. Therefore, an alternative strategy is to temporarily bond thin glass wafers to a silicon backing wafer to mitigate or prevent warpage and fracture of the borosilicate glass wafer during anodic bonding. The adhesive between the thin glass wafer and the Si backing wafer can be easily removed after anodic bonding.

At 804, verification of the bond between the spacer wafer and window wafer is performed. In some implementations, the verification includes evaluating the Au/Si eutectic bond between the spacer wafer and window wafer. In these implementations, a C-mode scanning acoustic microscope or X-ray camera can be used to verify a low-void Au/Si eutectic bond between the spacer wafer and the window wafer. In other implementations, the verification includes evaluating the anodic bond between the spacer wafer (e.g., that comprises borosilicate glass) and the window wafer. In those implementations, a C-mode scanning acoustic microscope or X-ray camera can be used to verify a void-free glass bond between the spacer wafer and the window wafer. In still other implementations, the verification includes evaluating the solder bond between the Invar spacer wafer and the window wafer. In these implementations, a C-mode scanning acoustic microscope or X-ray camera can be used to verify a void-free solder bond between the Invar spacer wafer and the window wafer. In still other implementations, the verification includes evaluating the anodic bond between the spacer wafer (e.g., including Si) and the borofloat 33 glass window wafer. In these implementations, a C-mode scanning acoustic microscope or X-ray camera can be used to verify a low-void anodic bond between the spacer wafer and the window wafer.

At 806, discrete metal frames suitable for wafer bonding are formed on the top face (i.e., the cavity side) of the WCW. In some implementations, each metal frame is located immediately around each cavity. In some implementations, the streets between the cavities can be electroplated with gold, gold-tin, or copper. At 808, a getter thin film is deposited inside the cavities of the WCW. In some non-limiting examples, the getter can be deposited by sputtering or evaporation through a shadow mask. The getter thin film can be configured to maintain a sufficient vacuum level despite the degassing of elements by adsorbing emitted gases.

At 810, the WCW can be bonded under vacuum to the ROIC/microbolometer wafer by applying pressure and temperature of 290-320° C. to form an array of hermetic AuSn solder joints. Advantageously, the temperature treatment for AuSn solder formation and reflow does not cause reflow of the AuSi solder bond previously formed between the spacer wafer and the window wafer. The temperature required for AuSn solder formation and reflow will not reflow the anodic glass bond previously formed between the Si spacer wafer and the window wafer. If the WCW is up-plated with Cu, the WCW can then be bonded under vacuum to the ROIC/microbolometer wafer by applying pressure and temperature of 290-350° C. to form an array of hermetic CuSn solder joints. The temperature required for CuSn solder formation and reflow will not cause reflow the anodic glass bond between the spacer wafer and the window wafer.

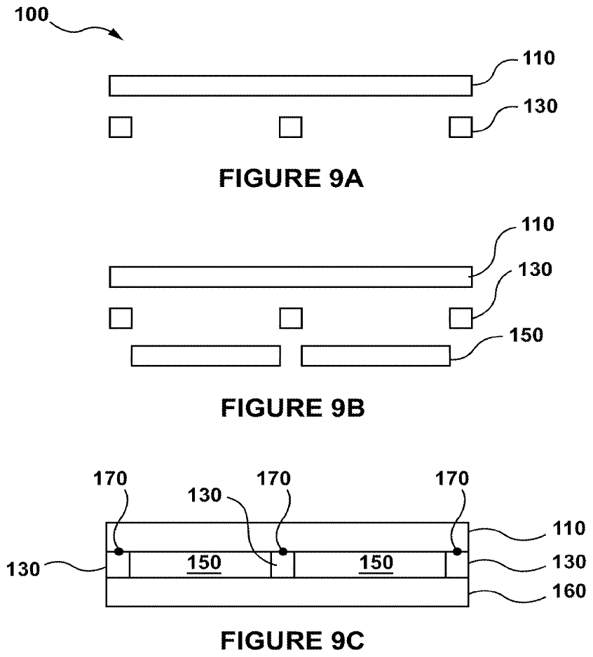

FIGS. 9A through 9C show steps for forming a window cavity wafer by laser bonding a window wafer and a spacer wafer together that have each been fabricated separately. In FIG. 9A, the window wafer 110 is positioned over the perforated the spacer wafer 130. In FIGS. 9B and 9C, an encapsulated device, such as an electrical component, is positioned between the spaces in the perforated spacer wafer 130 and hermetically sealed within by bonding of another wafer substrate 160 to the perforated spacer wafer 130 such that the electrical component 150 is hermetically sealed between the window wafer 110, spacer wafer 130, and the additional wafer substrate 160. Laser bonding of the spacer wafer 130 to the window wafer 110 by laser treatment at the laser treatment sites 170.

It will be appreciated that various of the above-disclosed and other features and functions, or alternatives thereof, may be desirably combined into many other different systems or applications. It will be further appreciated that various presently unforeseen or unanticipated alternatives, modifications, variations or improvements therein may be subsequently made by those skilled in the art which are also intended to be encompassed by the following claims.

1. A window cavity wafer, comprising:
a window wafer including a window wafer substrate and one or more optical coatings disposed on one or more faces of the window wafer substrate; and
a spacer wafer including a spacer wafer substrate,
wherein the spacer wafer is wafer bonded to the window wafer to form the window cavity wafer, and wherein the window cavity wafer includes metal frames.

2. The window cavity wafer of claim 1, wherein the one or more optical coatings comprises one or more of an antireflective coating, an optical filter coating, and/or a long-pass blocker coating.

3. The window cavity wafer of claim 1, wherein:
the window wafer substrate has a thickness between 300 μm and 1000 μm, and the window wafer substrate comprises one of: silicon (Si), germanium (Ge), borofloat glass, or sapphire; and/or
the spacer wafer substrate has a thickness between 100 μm and 500 μm, and the spacer wafer substrate comprises one of: glass, sapphire, ceramic, silicon (Si), or metal alloy.

4. (canceled)

5. The window cavity wafer of claim 1, further comprising:
a diamond-like carbon (DLC) coating disposed over one of the optical coatings.

6. The window cavity wafer of claim 1, wherein one or more metal layers are disposed on one or more faces of the spacer wafer substrate.

7. The window cavity wafer of claim 6, wherein the one or more metal layers comprise seed layer stacks, the seed layer stacks comprising one of:
$$\begin{matrix}( i ) Cr + Ni + Au ; or \\ ( ii ) Ti + Pt + Au .\end{matrix}$$

8-9. (canceled)

10. The window cavity wafer of claim 1, wherein the spacer wafer substrate is perforated.

11. The window cavity wafer of claim 6, further comprising:
a metal plating layer disposed over one of the metal layers.

12. The window cavity wafer of claim 1, further comprising:
a glass layer disposed on the spacer wafer substrate.

13. The window cavity wafer of claim 1, further comprising:
a getter disposed inside cavities of the window cavity wafer.

14. A method for forming a window cavity wafer, comprising:
fabricating a window wafer by:
providing a window wafer substrate having two faces;
etching one or more faces of the window wafer substrate; and
applying one or more optical coatings to on one or more faces of the window wafer substrate;
fabricating a spacer wafer separate from the window wafer by:
providing a spacer wafer substrate having two faces; and
forming an array of through-holes in the spacer wafer substrate;
bonding the spacer wafer to the window wafer to form the window cavity wafer; and
forming discrete metal frames on a face of the window cavity wafer.

15. The method of claim 14, further comprising:
depositing one or more metal layers on one or more faces of the spacer wafer substrate.

16. The method for forming the window cavity wafer of claim 15, further comprising:
depositing a getter inside cavities of the window cavity wafer; and
bonding the window cavity wafer to a readout integrated circuit.

17. The method of claim 14, wherein the applied one or more optical coatings include one or more of an antireflective coating, an optical filter coating, and/or a long-pass blocker coating.

18. The method of claim 14, wherein;
the provided window wafer substrate has a thickness between 300 μm and 1000 μm, and the provided window wafer substrate is one of: silicon (Si), germanium (Ge), borofloat glass, or sapphire; and/or
the provided spacer wafer substrate has a thickness between 100 μm and 500 μm, and the provided spacer wafer substrate comprises one of: glass, sapphire, ceramic, or metal alloy.

19. (canceled)

20. The method of claim 14, further comprising:
depositing a diamond-like carbon (DLC) coating over one of the optical coatings.

21. The method of claim 15, wherein the deposited one or more metal layers comprise seed layer stacks, wherein the seed layer stacks comprise one of:
$$\begin{matrix}\underline{( i ) Cr + Ni + Au ; or} \\ \underline{( ii ) Ti + Pt + Au} .\end{matrix}$$

22-24. (canceled)

25. The method of claim 15, further comprising:
depositing a metal plating layer over one of the metal layers.

26. The method of claim 14, further comprising:
disposing a glass layer on one face of the spacer wafer substrate.

27. A method for forming a window cavity wafer, comprising:
fabricating a window wafer by:
providing a window wafer substrate having two faces;
etching one or more faces of the window wafer substrate; and
applying one or more optical coatings to on one or more faces of the window wafer substrate;
fabricating a spacer wafer separate from the window wafer by:
providing a spacer wafer substrate having two faces; and
forming cavities on the faces of the spacer wafer substrate;
bonding the spacer wafer to the window wafer to form the window cavity wafer; and
forming discrete metal frames on a face of the window cavity wafer.
